(19) United States
(12) Patent Application Publication
(10) Pub. No.: US 2004/0201615 A1
(43) Pub. Date: Oct. 14, 2004

(54) Eliminating extraneous displayable data from documents and e-mail received from the world wide web and like networks

(75) Inventors: Timothy Alan Dietz, Austin, TX (US); Walid Kobrosly, Round Rock, TX (US); Nadeem Malik, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 10/411,417

(22) Filed: Apr. 10, 2003

(51) Int. Cl. G09G 5/00

(52) U.S. Cl. 345/738

(57) ABSTRACT

A system, method and related computer program for eliminating extraneous data from displayable received network, e.g. Web documents and E-mail that are independent of the format structure of the received document. An interactive browser associated with each of the receiving stations in the network, accesses received documents from the network and displays the documents at any receiving display station. This network browser includes means for superimposing a transparent displayed layer over the displayed received document, together with means enabling a user to designate, in the superimposed layer, data in the underlying displayed document page required by the user. The browser further includes means for copying the designated data into said superimposed layer to thereby create a secondary document having a document format structure that is independent of the format structure of the underlying received document. There is provided means for storing this secondary document in association with the browser that is independent of said received Web document.

### TECHNICAL FIELD

The present invention relates to computer managed communication networks such as the World Wide Web (Web) and, particularly, to systems, processes and programs for making the interactive user display interface to documents and E-mail received from the Web easier to use.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

Also, as a result of the rapid expansion of the Web, E-mail, which has been distributed for over 25 years over smaller private and specific purpose networks, has moved into distribution over the Web because of the vast distribution channels that are available. The availability of extensive E-mail distribution channels has made it possible to keep all necessary parties in business, government and public organizations completely informed of all transactions that they need to know about at almost nominal costs.

However, in the era of the Web, we do not have the situation of a relatively small group of professional designers working out the human factors; rather, anyone and everyone can design a Web document or E-mail document structure. As a result, Web and E-mail documents are frequently set up and designed in an eclectic manner. This often results in extraneous text/image clutter and/or advertising on documents or E-mail received from the Web or like private networks.

It is often the case that the user who receives a Web document or E-mail wishes to just save the gist of the information thereon and eliminate extraneous material. For example, a person has ordered some printer paper over the Web via E-mail. He receives an E-mail with vital data such as the shipping date, carrier and tracking number. The E-mail also contains a lot of extraneous data of little current interest to the user; e.g. other products of shipper, as well as interactive dialog boxes for ordering such other products. It is currently very difficult for the user to extract from the E-mail and save the vital data without the extraneous data. If the received E-mail document has the same document format structure, i.e. is created with a text processing program that is the same as the text processing program available at the user's receiving display station, then the same text processing program may be used to edit the received document or E-mail to eliminate the extraneous material.

Unfortunately, with the wide diversity of E-mail structure formatting programs on which Web documents and E-mail may be formatted at their respective sources, it is unlikely that a received document or E-mail would be formatted by a text processing program that is the same as that available at the receiving station. In addition, it is often difficult, if not impossible, for the receiving user to determine by what process the received document had been formatted.

With some text processing systems, there are routines available for converting documents with certain specified other format structures into documents having the format of the text processing system so that the documents may be processed by the instant system. Thus, under specified conditions with such programs, it may be possible to convert the received E-mail or other Web document into an appropriate format and then edit the document to remove extraneous material. This would add a very undesirable complexity to the efforts of the average public or consumer user of the Web who may be assumed to have very limited data processing skills. In addition, it may often not be easy to determine the document format structure of a received Web document or E-mail so that even a sophisticated user would be able to effect a permitted document format transition and then remove extraneous information.

### SUMMARY OF THE PRESENT INVENTION

The present invention provides a solution to the above-recited problems by a system, method and related computer program for eliminating extraneous data from a displayable received network, e.g. Web documents and E-mail that are independent of the format structure of the received document. The invention is operable in a communication network environment with user access via a plurality of data processor controlled interactive receiving display stations for displaying received documents of at least one display page, e.g. Web documents and E-mail containing formatted text and image data, available from sources on the network. The system comprises interactive browser means associated with each of said receiving stations for accessing received documents from the network and displaying the documents at any receiving display station. This network browser includes means for superimposing a transparent displayed layer over the displayed received document, together with means enabling a user to designate, in the superimposed layer, data in the underlying displayed document page required by the user. The browser further includes means for copying the designated data into said superimposed layer to thereby create a secondary document having a document format structure that is independent of the format structure of the underlying received document.

In accordance with another aspect of the invention, there is provided means for storing this secondary document in association with the browser that is independent of said received Web document.

Also, the uncopied extraneous graphics and text remaining in the underlying Web document is often undesired advertising material.

The invention further provides means for adding text and graphics to said secondary document independent of said received Web document.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a central processing unit that provides the computer controlled interactive display system that may be used in practicing the present invention;

FIG. 2 is a generalized diagrammatic view of a Web portion upon which the present invention may be implemented;

FIG. 3 is a diagrammatic view of a typical network E-mail page displayed at a receiving display station;

FIG. 4 is the diagrammatic E-mail page view of FIG. 3, after a user has that portion of the E-mail to be saved as a secondary document in accordance with the present invention;

FIG. 5 is an illustration showing how the E-mail page view of FIG. 4 may be separated into its secondary document formed in a superimposed display layer and the original E-mail in the underlaying display layer;

FIG. 6 is an illustrative flowchart describing the setting up of the process of the present invention for extracting desired data into a secondary document in an overlaying layer superimposed on the underlying original E-mail page; and

FIG. 7 is a flowchart of an illustrative run of the process setup in FIG. 6.

### DETAILED DESCRIPTION OF THE PREFERRED EMBODIMENT

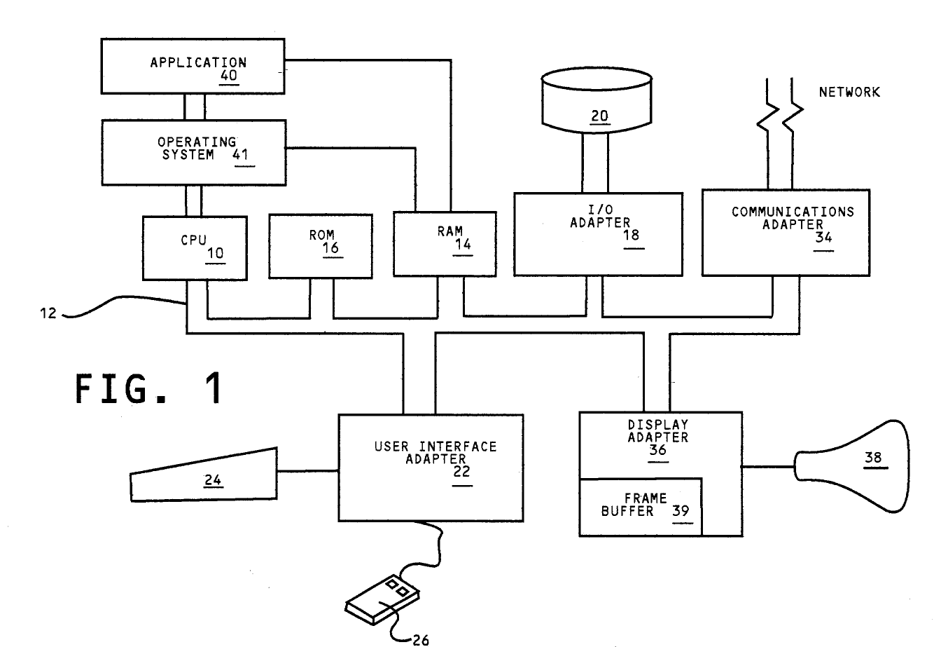

Referring to FIG. 1, a typical data processing terminal is shown that may function as the Web display station used for receiving Web pages, E-mail, browsing and requesting Web documents from sources on the Web. A central processing unit (CPU) 10, such as one of the PC microprocessors or workstations, e.g. RISC System/6000™ series available from International Business Machines Corporation (IBM) or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; or Microsoft's WindowsXP™, Windows2000™ or WindowsNT™, as well as other UNIX and AIX operating systems. Application programs 40, controlled by the system, are moved into and out of the main memory Random Access Memory (RAM) 14. These programs include the programs of the present invention for extracting desired data into a secondary document in an overlaying layer superimposed on the underlying original E-mail page. The programs will be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents, such as Web pages transmitted over networks, an understanding of networks and their operating principles would be helpful. We will not go into great detail in describing the networks to which the present invention is applicable. Reference has also been made to the applicability of the present invention to a global network such as the Internet or Web. For details on Internet nodes, objects and links, reference is made to the text, Mastering the Internet, G. H. Cady et al., published by Sybex Inc., Alameda, Calif., 1996.

The Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. In this connection, the term “documents” is used to describe data transmitted over the Web, or other networks, and is intended to include Web pages with displayable text, graphics and other images.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. The images on the Web pages are implemented in a variety of image or graphic files such as MPEG, JPEG or GIF files, which are described in the text, Internet: The Complete Reference, Millennium Edition, Young et al., 1999, Osborne/McGraw-Hill, particularly at pp. 728-730.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers. The invention may involve the use of search engines for searching. As described in the above-mentioned Internet: The Complete Reference, Millennium Edition text, pages 395 and 522-535, search engines use key words and phrases to query the Web for desired subject matter.

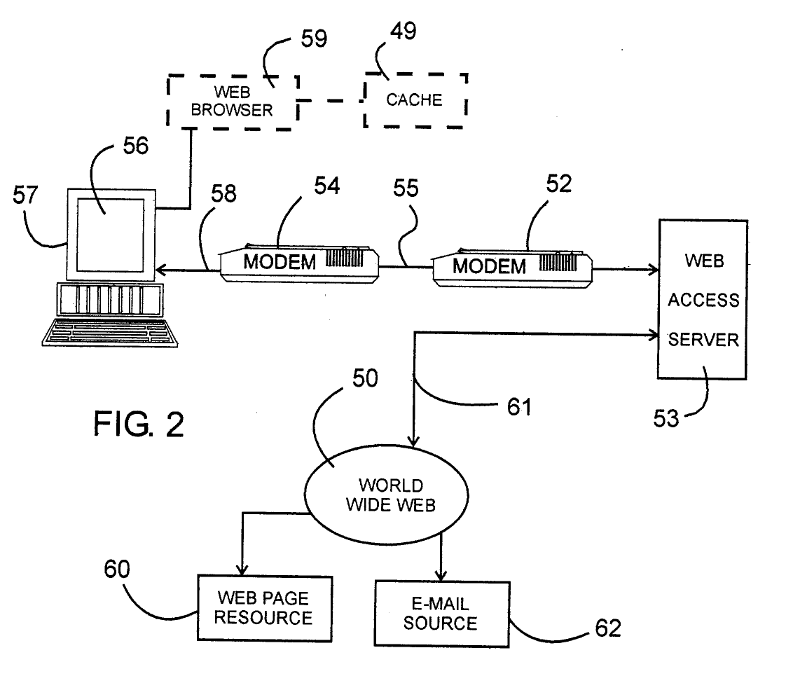

While the present invention may effectively be used in a private network environment, for convenience in illustration, a generalized portion of the Web as shown in FIG. 2 will be used. A generalized diagram of a portion of the Web, which the computer controlled display terminal 57 used for Web page receiving, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and is functioning running programs in a desktop or workspace environment on display 56. What is displayed may be electronic documents in the form of E-mail or other Web documents or pages. Reference may-be made to the above-mentioned Mastering the Internet, pp. 136-147, for typical connections between local display workstations to the Internet via network servers, any of which may be used to implement the system on which this invention is used. The system embodiment of FIG. 2 is one of these known as a host-dial connection. Such host-dial connections have been in use for over 30 years through network access servers 53 that are linked 51 to the Internet 50. High speed cable modems are now replacing the telephone lines. The servers 53 are maintained by a service provider to the client's display terminal 57. The host's server 53 is accessed by the client terminal 57 through a normal dial-up telephone or high speed cable linkage 58 via modem 54, line 55 and modem 52. The files representative of the Web pages, E-mail or messages are downloaded to display terminal 57 through controlling server 53 via the telephone or cable line linkages from server 53 that has accessed them from the Internet 50 via linkage 61. Web browser 59 controls the Web page/E-mail accessing and messaging display functions being described, including communications to and from sources 60 and 62 via Web 50. Browser 59 has an associated cache for temporary storage of documents and E-mail obtained from the network through the browser. Web server 53 will carry out the functions of obtaining the Web documents or pages as requested by the user via Web browser 59 and downloaded into storage in Web cache 49.

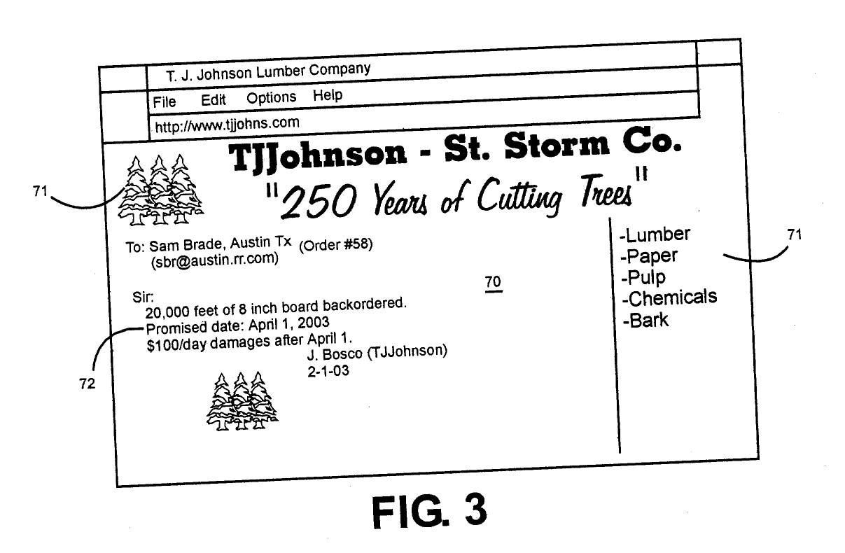

With this setup, the present invention, that will be described in greater detail with respect to FIGS. 3 through 5, may be carried out using Web browser 59 and associated Web server 53 (FIG. 2).

Now, with respect to FIGS. 3 through 5, we will give an illustrative example of how the present invention may be used to provide an implementation for extracting desired data into a secondary document in an overlaying layer superimposed on the underlying original E-mail or Web page. For purposes of this illustrative embodiment, assume that an E-mail document 70 has been received at a display station. The purpose of the E-mail is to confirm the receipt of an order of board feet that has been back ordered. The information important to the user is in E-mail portion 72 that sets forth the description of the back ordered material, the date promised, the liquidated damages for delivery delay, the order number, the shipper and the purchaser. The user is only interested in this information. However, the E-mail contains considerable extraneous information 71 that is of no interest to the user. This includes the vendor company logos and slogans, some illustrative graphics and a listing of links to other product lines of the vendor. For the purpose of saving the E-mail data, that is, to follow-up on the back order, information 71 is extraneous and of no interest to the receiver of the E-mail.

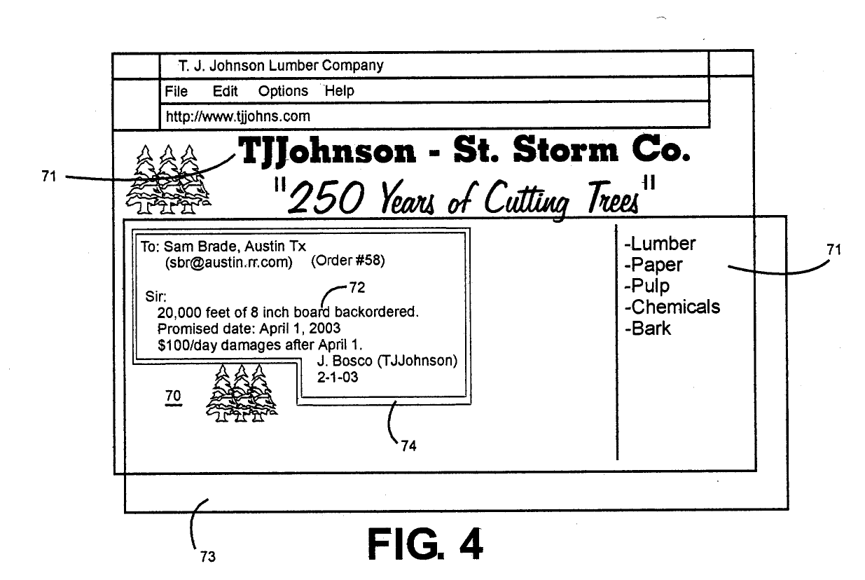

Accordingly, as shown in FIG. 4, the user employs the standard graphics available with the operating system, e.g. Windows 2000 to highlight or likewise define 74 the important portion 72 of the E-mail page 70. This indicates that the user intends to extract or copy portion 72 into a virtual superimposed or overlayer 73 which is independent of layer containing the underlying full E-mail page 70. This extraction or copying may be defined at the display frame buffer during the display of the E-mail. Referring back to the basic display computer system of FIG. 1, display adapter 36 includes a frame buffer 39 that is a storage device that holds a representation of each pixel on the display screen 38. Frame buffer images may be stored in frame buffer 39 for display on monitor 38 on a number of frame levels. Accordingly, under control of the browser program, the defined 74 portion 72 of the E-mail to be extracted in FIG. 4 is scanned and directly copied from the underlying frame buffer layer containing the whole E-mail into an overlaying frame buffer layer 73 containing only the desired portion 72. This function utilizes the conventional ability of the browser to render the received E-mail or Web page images into frame buffer layer pixel array images that are displayed. Having such a stored pixel array image for the whole original E-mail, the defined information to be extracted into the secondary may be readily lifted and stored separately within the browser cache. Since the pixel array image of the original E-mail is wholly independent of the document format structure of this original E-mail, the extracted pixel array image of this secondary document will also be independent.

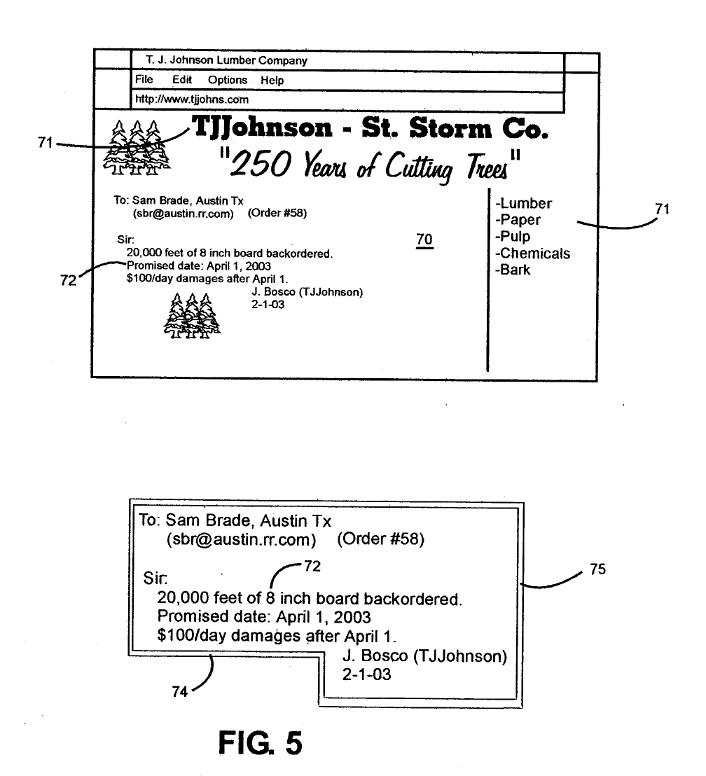

As a result, shown in FIG. 5, there are two separate documents: the whole basic E-mail 70 available at one level in the frame buffer, and the extracted or copied selected information 72 available as an independent secondary document 75 at a different frame buffer overlying layer. The primary and secondary E-mail documents may then be stored, at least temporarily, in the cache 49 of browser 59 (FIG. 1), and either may be displayed and/or printed as desired. When printed, the secondary documents containing only necessary information will reduce costs by eliminating the printing of extraneous information. In addition, since the secondary document is stored on the Web browser cache as a pixel mapped document, it may then be converted into any document structure format should it be desired to edit the secondary document in any way.

FIG. 5 is a flowchart showing the development of a process according to the present invention for extracting desired data into a secondary document in an overlaying layer superimposed on the underlying original E-mail or Web page. Most of the programming functions in the process of FIG. 5 have already been described in general with respect to FIGS. 3 through 5. A Web browser is provided at a receiving display station on the Web for accessing Web pages and E-mail, step 80, in the conventional manner and loading them at the display station, step 81. The Web pages are conventionally obtained via a Web server provided by an Internet Service Provider (ISP). The Web browser has the capability of requesting searches from one or more search engines available through the Web. There is provided in association with the browser a conventional storage device, e.g. cache for storing the received Web document or E-mail in its original document structure format, step 82. Under the browser control, there is provided for the conventional display of received Web documents and E-mail that would be stored on the browser cache, step 83. There is provision for the overlay of a transparent layer in the display over the displayed Web page or E-mail, step 84. Provision is made to enable the user to selectively highlight or otherwise designate portions of data in the displayed E-mail or Web page, step 85. Provision is made for the copying of the highlighted portions of data into storage, step 86, separate from the storage of the received E-mail or Web document of step 82, and in a document structure format independent of the structure format of the E-mail or Web document. The user is enabled, step 87, to display, send or print the data stored in step 86 independent of the original received E-mail or Web document.

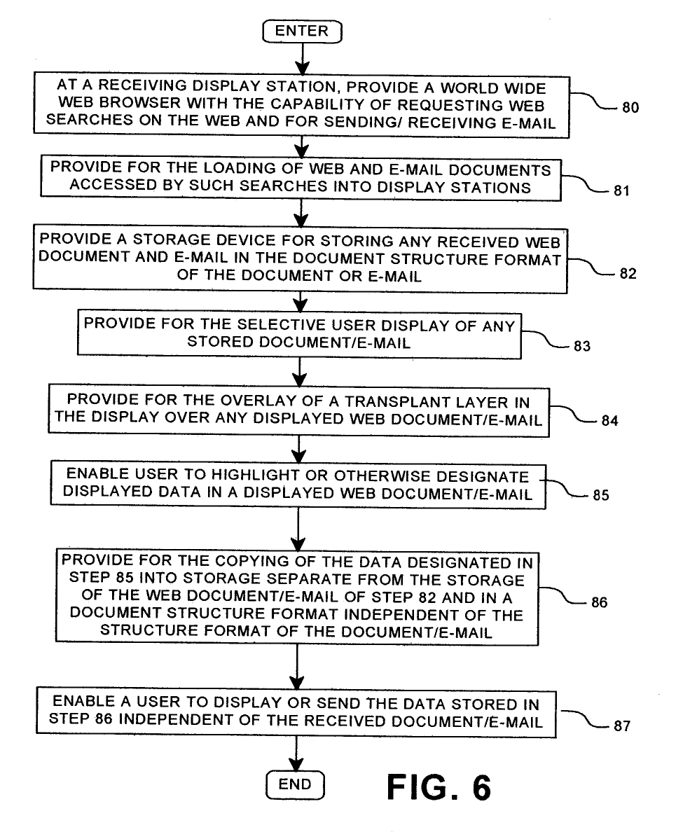

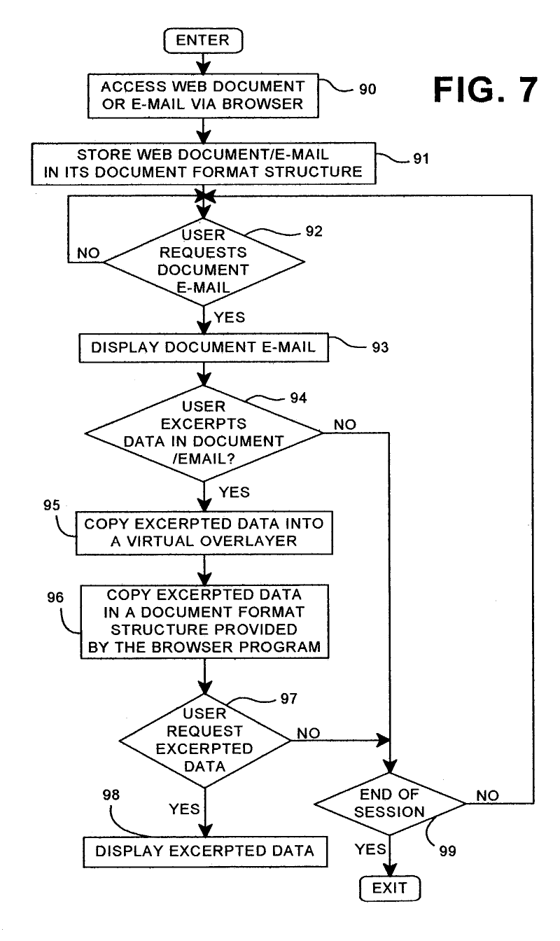

The running of the process set up in FIG. 6 and described in connection with FIGS. 3 through 5 will now be described with respect to the flowchart of FIG. 7. Let us assume that we are in a Web browser controlled session. The flowchart represents some steps in a routine that will illustrate the operation of the invention. The browser, via a Web access server, accesses the pages found by a search engine or receives an E-mail, step 90. The next Web document or E-mail is stored in its original document structure format in association with the browser, step 91. A determination is then made as to whether the user has requested the E-mail document, step 92. If No, such a request is awaited. If Yes, the E-mail page is displayed, step 93. During the display of this Web page, a determination is made as to whether the user has highlighted any numerical data items on the displayed Web page so that he may excerpt the data, step 94. If Yes, the browser copies into a virtual superimposed layer, step 95, and thus stores the highlighted and excerpted items as a secondary document separate from the E-mail page, step 96, in a basic pixel array document format structure provided by the browser. Then, a determination is made as to whether the user has requested the excerpted secondary document, step 97. If Yes, the excerpted secondary document is displayed, step 98. If No, or if the decision from either step 94 or 97 had been No, a further determination is made as to whether the session is at an end. If Yes, the session is exited. If No, then the process is branched back to step 92 where the next E-mail or Web document is awaited.

One of the preferred implementations of the present invention is in application program 40, i.e. a browser program made up of programming steps or instructions resident in RAM 14, FIG. 1, of a Web receiving station and/or Web server during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a communication network with user access via a plurality of data processor controlled interactive receiving display stations for displaying received documents of at least one display page containing formatted text and image data, and available from sources on the network, a system for eliminating extraneous displayable data from received documents comprising:
network interactive browser means associated with each of said receiving stations for accessing said received documents from the network and displaying said documents at said receiving display stations;
said network browser means further including:
means for superimposing a transparent displayed layer over said displayed received document;
means enabling a user to designate, in said superimposed layer, data in said underlying displayed document page required by said user; and
means for copying said designated data into said superimposed layer to thereby create a secondary document having a document format structure independent of the format structure of the underlying received document.

2. The communication network of claim 1 wherein said communication network is the World Wide Web (Web), and said network documents are Web documents.

3. The Web network of claim 2 wherein said documents are E-mail documents.

4. The Web network of claim 3 further including means for storing said secondary document independent of said received Web document.

5. The Web network of claim 2 wherein there is uncopied extraneous graphics and text remaining in said underlying Web document.

6. The Web network of claim 5 wherein the uncopied extraneous graphics and text remaining in said underlying Web document is advertising material.

7. The Web network of claim 3 further including means for adding text and graphics to said secondary document independent of said received Web document.

8. The Web network of claim 2 wherein the means in said browser means for copying said designated data includes:
means for rendering said received Web document into a displayable pixel array; and
wherein said means for copying copies said designated data as a portion of said pixel array to create said secondary document.

9. In a communication network with user access via a plurality of data processor controlled interactive receiving display stations for displaying received documents of at least one display page containing text and images, and available from sources on the network, a method for eliminating extraneous displayable data from received documents comprising:
a network interactive browser process associated with each of said receiving stations for accessing said received documents from the network and displaying said documents at said receiving display stations;
said network browser process further including the steps of:
superimposing a transparent displayed layer over said displayed received document;
enabling a user to designate, in said superimposed layer, data in said underlying displayed document page required by said user; and
copying said designated data into said superimposed layer to thereby create a secondary document having a document format structure independent of the format structure of the underlying received document.

10. The method of claim 9 wherein said communication network is the Web, and said network documents are Web documents.

11. The method of claim 10 wherein said documents are E-mail documents.

12. The method of claim 11 further including the step of storing said secondary document independent of said received Web document.

13. The method of claim 10 wherein there is uncopied extraneous graphics and text remaining in said underlying Web document.

14. The method of claim 13 wherein the uncopied extraneous graphics and text remaining in said underlying Web document is advertising material.

15. The method of claim 11 further including the steps of enabling a user to add text and graphics to said secondary document independent of said received Web document.

16. The method of claim 9 wherein the step in said browser process for copying said designated data includes:
rendering said received Web document into a displayable pixel array; and
copying said designated data as a portion of said pixel array to create said secondary document.

17. A network browser computer program having code recorded on a computer readable medium associated with each of said receiving stations for eliminating extraneous displayable data from received documents in a communication network with user access via a plurality of data processor controlled interactive receiving display stations for displaying received documents of at least one display page containing text and images, and available from sources on the network, said browser program comprising:
means for accessing said received documents from the network and displaying said documents at said receiving display stations;
means for superimposing a transparent displayed layer over said displayed received document;
means enabling a user to designate, in said superimposed layer, data in said underlying displayed document page required by said user; and
means for copying said designated data into said superimposed layer to thereby create a secondary document having a document format structure independent of the format structure of the underlying received document.

18. The computer program of claim 17 wherein said communication network is the Web, and said network documents are Web documents.

19. The computer program of claim 18 wherein said documents are E-mail documents.

20. The computer program of claim 19 further including means for storing said secondary document independent of said received Web document.

21. The computer program of claim 18 wherein there is uncopied extraneous graphics and text remaining in said underlying Web document.

22. The computer program of claim 21 wherein the uncopied extraneous graphics and text remaining in said underlying Web document is advertising material.

23. The computer program of claim 19 further including means for adding text and graphics to said secondary document independent of said received Web document.

24. The computer program of claim 18 wherein the means in said browser means for copying said designated data includes:
means for rendering said received Web document into a displayable pixel array; and
wherein said means for copying copies of said designated data as a portion of said pixel array to create said secondary document.

25. In a communication network with user access via a plurality of data processor controlled interactive receiving display stations for displaying received documents of at least one display page containing formatted text and image data, and available from sources on the network, a system for eliminating extraneous displayable data from received documents comprising:
a receiving display station for displaying a received network document;
an interactive network browser associated with said receiving display station for accessing said received document from the network and displaying said document at said receiving display station;
said network browser further including:
an implementation for superimposing a transparent displayed layer over said displayed received document;
an implementation for enabling a user to designate, in said superimposed layer, data in said underlying displayed document page required by said user; and
an implementation for copying said designated data into said superimposed layer to thereby create a secondary document having a document format structure independent of the format structure of the underlying received document.

26. The communication network of claim 25 wherein said communication network is the Web, and said network documents are Web documents.

27. The Web network of claim 26 wherein said documents are E-mail documents.

28. The Web network of claim 24 further including means for storing said secondary document independent of said received Web document.

29. The Web network of claim 26 wherein there is uncopied extraneous graphics and text remaining in said underlying Web document.

30. The Web network of claim 29 wherein the uncopied extraneous graphics and text remaining in said underlying Web document is advertising material.

31. The Web network of claim 27 further including means for adding text and graphics to said secondary document independent of said received Web document.

32. The Web network of claim 26 wherein the implementation in said Web browser for copying said designated data includes:
apparatus for rendering said received Web document into a displayable pixel array; and
wherein said implementation for copying copies of said designated data as a portion of said pixel array to create said secondary document.
